(19) United States
(12) Patent Application Publication
(10) Pub. No.: US 2018/0202601 A1
(43) Pub. Date: Jul. 19, 2018

(54) TREE MOUNTABLE DEVICE HOLDER FOR HUNTING

(71) Applicant: Kameron D. Kelly, Bonner Springs, KS (US)

(72) Inventor: Kameron D. Kelly, Bonner Springs, KS (US)

(21) Appl. No.: 15/873,655

(22) Filed: Jan. 17, 2018

Related U.S. Application Data
(60) Provisional application No. 62/447,093, filed on Jan. 17, 2017.

(51) Int. Cl. F16M 13/02; F16M 13/00; A45F 5/00

(52) U.S. Cl. CPC F16M 13/022; F16M 13/005; F16M 2200/08; A45F 2005/002; A45F 2200/0516; A45F 5/00

(57) ABSTRACT

A phone-holding system having a base member and a phone mount coupled to the base member. The base member can be a tree mountable articulating arm, an adhesive base, a magnetic base, a cupholder base, a 12-volt charging base, and/or a CD-slot base. The phone mount can include a multi-axis articulating member and a phone-holding member. The multi-axis articulating member can be a ball hinge and/or a self-holding elongated gooseneck member. The phone holder can be a magnetic phone mount or a physical phone mount. The system employs a universal connection mechanism (e.g., a standard threaded projection and opening) for attaching the bases to the phone holders, so that a variety of different bases can be used interchangeably with a variety different phone mounts.

### CROSS-REFERENCE TO RELATED APPLICATION

This application claims the benefit under 35 U.S.C. § 119(e) of U.S. Provisional Application Ser. No. 62/447,093, filed on Jan. 17, 2017, the entire disclosure of which is incorporated herein.

### BACKGROUND

The present disclosure relates to systems for holding phones. Mobile phones have become an integral part of everyday life for persons throughout the world. Even when performing tasks that do not require a mobile phone, many individuals still like to have their phone close at hand and viewable. Certain activities, such as driving a car, typing, and hunting in a tree stand, require the use of both hands. During such two-handed activities it would be desirable to have a mobile phone mounted near the user in a position that is stable, viewable, and easily manipulatable. Further, it would be desirable to have a phone mounting system that uses similar and/or interchangeable components to mount a phone at a variety of locations.

### SUMMARY

In accordance with one embodiment of the present invention, there is provided a tree mountable device holder comprising an articulating arm, a screw member, and a phone mount. The articulating arm includes at least two rigid arm segments and a single-axis hinge coupling the rigid arm segments to one another. The screw member is coupled to a first end of the articulating arm and the phone mount is coupled to a second end of the articulating arm. The phone mount includes a multi-axis articulating member and a phone-holding member configured to securely hold a phone. The multi-axis articulating member is coupled between the articulating arm and the phone-holding member and is configured to permit multi-axis articulation of the phone-holding member relative to the articulating arm.

In accordance with another embodiment of the present invention, there is provided a tree mountable device holder comprising an articulating arm, a self-tapping screw coupled to one end of the articulating arm, a male threaded projection coupled to the other end of the articulating arm, and a physical phone mount coupled to the articulating arm by the male threaded projection. The articulating arm includes first, second, and third rigid arm segments and first and second single-axis hinges. The first single-axis hinge couples the first and second rigid arm segments to one another, while the second single-axis hinge couples the second and third rigid arm segments to one another. The second rigid arm segment is coupled between the first and second rigid arm segments by the first and second hinges respectively. The pivot axes of the first and second hinges are substantially parallel to one another. The self-tapping screw is coupled to the first rigid arm segment at an end of the first rigid arm segment spaced from the first hinge. The male threaded projection is coupled to the third rigid arm segment at a location spaced from the second hinge. The physical phone mount includes a female threaded opening for receiving the male threaded projection. The physical phone mount includes a ball hinge and a phone-holding member configured to securely hold a phone. The phone-holding member comprises at least two opposing physical members for imparting a holding force on the phone.

In accordance with a further embodiment of the present invention, there is provided a method of using a device holder. The method comprises the steps of: (a) securing an arm base having a screw and an articulating arm to a tree via the screw; (b) manipulating the articulating arm into a desired position; (c) securing a phone to a phone mount coupled to the articulating arm; and (d) recording and/or playing video with the phone while the phone is held only by the phone mount.

### BRIEF DESCRIPTION OF THE DRAWINGS

FIG. 1 is a side view of a tree mountable phone holder according to one embodiment of the present invention.

FIG. 2 is a top view of the tree mountable phone holder depicted in FIG. 1 in a partially collapsed position, where the self-tapping screw of the tree mountable phone holder is being screwed into a tree.

FIG. 3 is a top view of the tree mountable phone holder depicted in FIG. 1 being attached to a tree near a tree stand.

FIG. 4 is a side view of a tree mountable arm base configured in accordance with a one embodiment of the present invention.

FIG. 5 is a side view of a test set-up for testing the holding capacity of a tree mountable arm base.

FIG. 6 is an isometric view of a tree mountable arm base configured in accordance with another embodiment of the present invention.

FIG. 7 is an isometric view of a tree mountable arm base configured in accordance with another embodiment of the present invention.

FIG. 8 is a side view of a tree mountable arm base configured in accordance with another embodiment of the present invention.

FIG. 9 is an isometric view of a tree mountable arm base configured in accordance with another embodiment of the present invention.

FIG. 10 is a side view of a universal phone mount configured in accordance with another embodiment of the present invention, where the phone mount includes a ball hinge.

FIG. 11 is a side view of a universal phone mount configured in accordance with another embodiment of the present invention, where the phone mount includes a flexible goose-neck support member.

FIG. 12 is a side view of a universal phone mount configured in accordance with another embodiment of the present invention, where the phone mount includes a ball and socket arrangement, with the ball and socket being held together by magnetic forces.

FIG. 13 is an isometric view of a universal phone mount configured in accordance with another embodiment of the present invention, showing the magnetic phone mount in relation to a phone.

FIG. 14 is an isometric view of the universal phone mount of FIG. 13, showing the magnet of the magnetic phone mount attracting a metallic plate housed in the phone.

FIG. 15 is a close-up isometric view of a universal phone mount configured in accordance with another embodiment of the present invention, where a magnetic force attaches the phone to the phone-holding member and to the ball.

FIG. 16 is an isometric view of the universal phone mount of FIG. 15, showing the phone mount holding a phone.

FIG. 17 is a side view of a universal phone mount configured in accordance with another embodiment of the present invention, showing a ball hinge having a rotatable friction adjustment collar.

FIG. 18 is an isometric view of the universal phone mount of FIG. 17.

FIG. 19 is a front isometric view of a universal phone mount configured in accordance with another embodiment of the present invention.

FIG. 20 is a back isometric view of the universal phone mount of FIG. 19.

FIG. 21 is an isometric view of a universal phone mount employing one type of physical grasping mechanism for physically grasping and holding a phone in place.

FIG. 22 is a side view of the universal phone mount of FIG. 21, showing the phone mount holding a phone.

FIG. 23 is an isometric view of a universal phone mount employing another type of physical grasping mechanism for physically grasping and holding a phone in place.

FIG. 24 is an isometric view of the universal phone mount of FIG. 23, showing the phone mount holding a phone.

FIG. 25 is a side view of one embodiment of a base suitable for use with a universal phone mount of the present invention, where the base includes an adhesive on the bottom of the base.

FIG. 26 is a side view of another embodiment of a base suitable for use with a universal phone mount of the present invention, where the base includes a bottom portion configured to be received in a standard automotive cup holder.

FIG. 27 is a side view of another embodiment of a base suitable for use with a universal phone mount of the present invention, where the base includes a suction cup on the bottom of the base.

FIG. 28 is a side view of another embodiment of a base suitable for use with a universal phone mount of the present invention, where the base includes a lower portion adapted to fit within standard 12 volt electrical.

FIG. 29 is an isometric view of another embodiment of a base suitable for use with a universal phone mount of the present invention, where the base includes a lower portion adapted to fit in the CD slot of an automotive CD player.

### DETAILED DESCRIPTION

One embodiment of the present invention relates to a tree mountable phone-holding system that includes a tree mountable articulating arm with a universal smart phone mount on the end. The universal smart phone mount can be a physical mount (i.e., physically grips the phone) or a magnetic mount (i.e., uses magnetic force to hold the phone).

This type of phone-holding system allows a hunter in a tree stand to (1) use a phone with his or her hands when there is no hunting action, (2) quickly and quietly mount the phone on the magnetic or physical holder when game is detected, (3) shoot hands free video of game while the hunter is calling, readying, aiming, and shooting, and (4) watch video on the phone while in the tree stand without having to manually hold up the phone. In certain embodiments, the phone-holding system can be mountable to the tree without the need for additional tools, so that no pre-drilling is required.

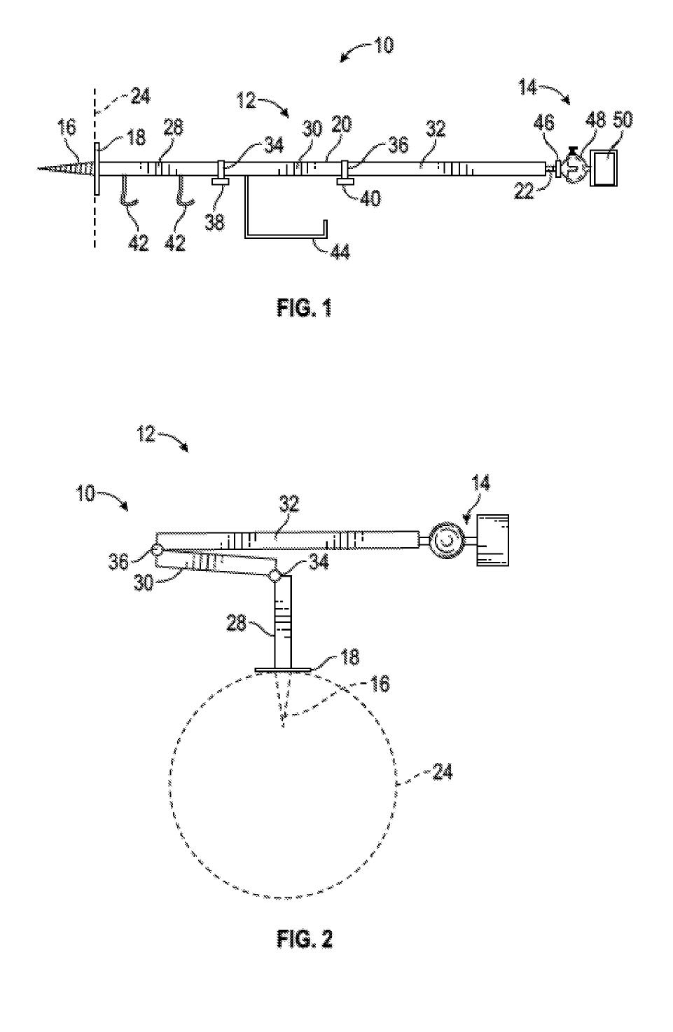

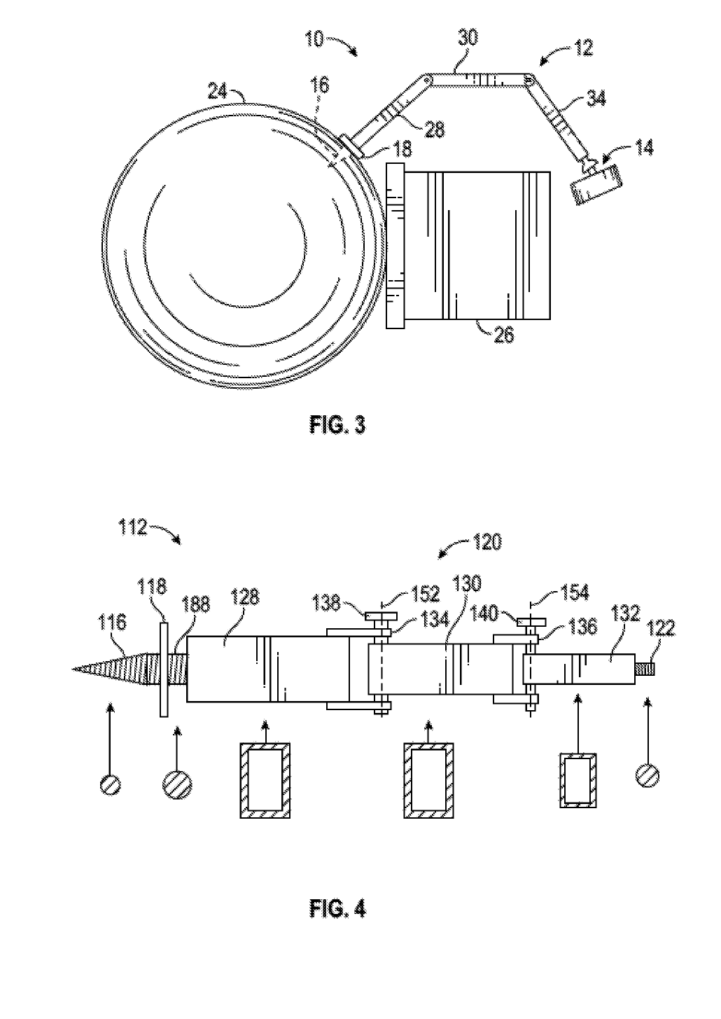

FIGS. 1-3 depict a tree mountable device holder 10 configured in accordance with one embodiment of the invention. FIG. 1 is a side view of the tree mountable device holder 10 in an extended position. FIG. 2, shows a top view of the device holder 10 in a retracted position. FIG. 3. shows a top view of the device holder in an intermediate position selected by the hunter.

As shown in FIG. 1, the tree mountable device holder 10 includes a tree mountable arm base 12 and a universal phone mount 14 connected to one end of the tree mountable arm base 12. The main components of the tree mountable arm base 12 include a self-tapping screw 16, a flange 18, a multi-segment articulating arm 20, and a male threaded member 22. The self-tapping screw 16 is located on one end of the multi-segment articulating arm 20, while the male threaded member 22 is located at or near the other end of the multi-segment articulating arm 20. The multi-segment articulating arm 20 includes a first arm segment 28, a second arm segment 30, and a third arm segment 32. A first hinge 34 couples the first and second arm segments 28,30 to one another. A second hinge 36 couples the second and third arm segments 30,32 to one another. Both the first and second hinges 34,36 can include stiffness adjustment/lock members 38,40 for adjusting the resistance to movement of the arm segments relative to one another. One or more accessory hooks 42 and/or an archery bow hook 44 can be attached to and extend downwardly from the multi-segment articulating arm 20.

The universal phone mount 14 of the tree mountable device holder 10 can include a base connection member 46, a multi-axis articulating member 48, and a phone-holding member 50. The base connection member 46 can be provided with a female threaded opening (not shown in FIG. 1) for removable attachment to/from the male threaded member 22 located at or near the distal end of the tree mountable arm base 12 (or another base, as discussed below).

As shown in FIGS. 2 and 3, the tree mountable device holder 10 can be connected to a tree 24 near a tree stand seat 26 (FIG. 3). The tree mountable device holder 10 can be connected to the tree 24 by screwing the self-tapping screw 16 into the tree 24, while the device holder 10 is in the position illustrated in FIG. 2. After the self-tapping screw 16 is screwed into the tree, the flange 18 adjacent the self-tapping screw 16 can be tightened against the tree 24 to provide significantly improved holding capacity verses screw-only (no flange) systems.

FIG. 4 provides added detail for a tree mountable arm base 112 configured according to another embodiment of the invention. FIG. 4 shows various cross-sections of various components along the length of the tree mountable arm base 112. The tree mountable arm base 112 includes a self-tapping screw 116, a flange 118, a threaded flange adjustment section 188, a first arm segment 128, a first hinge 134, a first stiffness adjustment/lock member 138, a second arm segment 130, a second hinge 136, a second stiffness adjustment/lock member 140, a third arm segment 132, and a threaded male member/projection 122. The first and second hinges 138,140 pivot on first and second hinge pivot axes 152,154, respectively. The first and second hinge pivot axes 152,154 are substantially parallel to one another and extend substantially vertically when the tree mountable arm base 112 is attached to a tree in its proper orientation. As such, the hinges 138,140 permit the second and third arm segments 130,132 to move in a substantially horizontal plane when the tree mountable arm base 112 is attached to a tree in its proper orientation.

FIG. 4 illustrates one way that the flange 118 can be moved axially relative to the screw 116. More specifically, the tree mountable arm base 112 includes the threaded flange adjustment section 118 on which the flange 118, which has a corresponding internally-threaded opening, can be adjusted by rotating the flange 118 relative to the flange adjustment section 188. In certain embodiments, the diameter of the flange 118 can be at least 1.5 times (possibly at least 2 times, at least 3 times, at least 4 times, or at least 5 times) greater than the maximum diameter of the screw 116. The flange 118 can be made of a metal disk that is at least ⅛ inch thick (possibly at least 3/16″ thick). The flange 118 can be adjustable relative to the screw 116 along the axis of extension of the screw so that the flange 118 is snug against the tree when tree mountable arm base 112 is in the proper orientation with (1) the second and third arm segments 130, 132 moving in a horizontal plane and (2) hooks (as described with reference to FIG. 1) hanging down. As indicated above, the flange 118 can have a threaded female opening for adjusting its position along the axis of the male threaded flange adjustment section 188. The threads on the flange 118 can be oriented so that when the flange 118 engages the tree, further rotation of the screw 116 while the flange 118 is stationary causes the flange 118 to move toward the tree (e.g., male threads on flange adjustment section 188 can be opposite of threads on the self-tapping screw 116).

In an alternative embodiment, an adjustable clamp (not shown) can be used to clamp and hold the flange 118 against the tree after the screw 116 has been screwed into the tree and the arm base 112 is properly oriented. Such a clamp causes the flange 118 to slide toward the tree on the flange adjustment section 188 of the arm base 112 for engagement with the tree and away from the tree on the flange adjustment section 188 of the arm base 112 for disengagement from the tree. In certain embodiments, the flange 118 can include sharpened projections or a roughened surface for preventing rotation of the flange 118 relative to the tree once the flange 118 engages the tree.

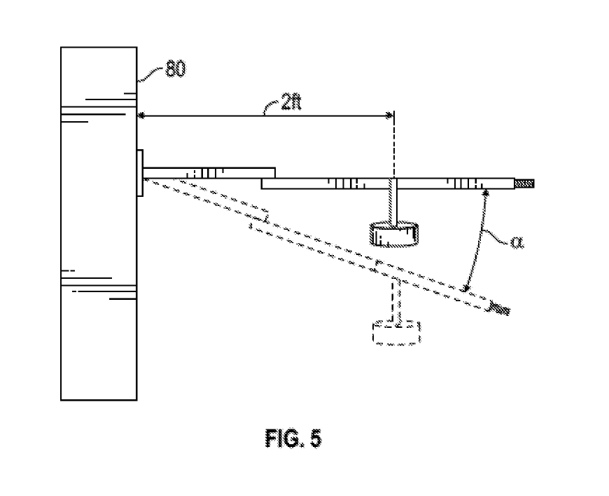

A holding capacity test can be used to determine the holding capacity of the tree mountable arm base. FIG. 5 depicts the test setup for the holding capacity test. As used herein, “holding capacity” is the amount of weight that can be held by the articulating arm in the fully extended position without causing the arm to deflect by and angle (α) more than 20 degrees from an initial horizontal state, where the weight is hung from the arm at a distance of two horizontal feet from a vertical wooden member 80 (representing a tree) into which the self-tapping screw is threaded and tightened until the flange firmly engages the wooden member. For purposes of the holding capacity test, the wooden member 80 is a Grade #1 untreated southern yellow pine 4×4. In addition, for purposes of the holding capacity test, the deflection angle (α) is the angle between the initial load point (2 ft from the wooden member) with 0 pounds loaded, the point where the screw enters the wooden member, and the final load point (2 ft from the wooden member) with the weight loaded on the load point. In certain embodiments, the holding capacity (at 2 feet) of the tree mountable arm base is at least 10 pounds, at least 20 pounds, at least 30 pounds, at least 40 pounds, at least 50 pounds, at least 60 pounds, at least 70 pounds, at least 80 pounds, at least 90 pounds, or at least 100 pounds. The holding capacity with the flange (described above) can be at least 1.5 times (possibly at least 2 times or at least 3 times) greater than the holding capacity without the flange.

Referring again to FIG. 4, the male threaded member 122 on the outer end of the arm base 112 can have the same type of threads as a standard camera tripod. Accordingly, the male threaded member 122 can have threads that are ¼ inch in diameter and 20 threads per inch. As discussed above, the phone mount (not shown in FIG. 4) can be threadably/releasably attached to the arm base 112 via this male threaded member 122. Alternatively, another releasable connection can be substituted for the male threaded member 122 to connect the phone mount to the end of the tree mountable arm base 112. Such alternative releasable connection could, for example, be a quick connect/disconnect mechanism that allows the phone mount to be easily connected and disconnected to other bases (described below). Alternatively, the male threaded member 122 can be eliminated and the phone mount can be permanently attached to the end of the tree mountable arm base 112.

Although FIG. 4 shows a multi-segment articulating arm 120 having three segments, the multi-segment articulating arm 120 could have 2, 3, or 4 rigid segments. The material of construction of each segment of the multi-segment articulable arm can be steel, aluminum, or fiber reinforced composite. The strength, size, and/or weight of the arm segments may decrease from the segment closest to the tree to the segment farthest from the tree in order to minimize weight of the arm, while maximizing strength where it is needed most (i.e., close to the tree). In certain embodiments, only two arm segments may be needed, especially if an elongated goose-neck style phone mount is used (see below).

As previously discussed, the first and/or second arm segments of the multi-segment articulating arm may include various attachment devices (e.g., hooks or magnets) for ready access to hunting accessories and/or weapons. Exemplary attachment devices include two or more accessory hooks for backpack, game calls, attractant devices, food, drink, or other items; a large bow hook for holding an archery bow; and a super-high-strength (>50 pound holding power) magnet (e.g., neodymium magnet) for holding the barrel of a gun, thereby safely but removably attaching a gun to the articulating arm. When such a high-strength magnet is used to hold a gun, the magnet can present a generally cylindrically concave vertical surface with a thin pad adhered to the curved surface to prevent scratching of the gun and to minimize sound when attaching and detaching the gun.

The first arm segment, which is attached to the tree, can have small accessory hooks for backpack, detached quiver, calls, etc. This first arm segment may be made of a thicker/stronger/heavier material than the second and/or third arm segments. The first arm segment can be 2-14 inches (possibly 4-12 inches or 6-10 inches) long.

The second arm segment can have a larger hook for hanging a bow (spaced from tree, but not too far). The second arm segment can be shorter than the first arm segment and may be made of a thicker/stronger/heavier material than the third arm segment and/or a thinner/weaker/lighter material than the first arm segment. The second arm segment can be 2-14 inches (possibly 4-12 inches or 6-10 inches) long.

The third arm segment has an end with a male threaded projection for attachment of a phone mount. In certain embodiments, the third arm segment has no hooks because it is too far out to hang much weight. The third arm segment may be made of a thinner/weaker/lighter material than the first and/or second segments. The third arm segment can be 2-14 inches (possibly 4-12 inches or 6-10 inches) long.

The hinges located between the arm segments only allow for horizontal movement of the arm (i.e., they are single-axis, vertical-axis hinges). The multi-segment articulatable arm can be shifted between a fully retracted/folded position and a fully extended position. It works well when screwing the arm base into a tree for the second and/or third arm segments to be at almost 90 degree angles (possibly 60-120 degree angles) relative to the first arm member and the self-tapping screw. In this configuration (shown in FIG. 2), the second and third arms provide torque for manually screwing into the tree.

In fully retracted position, the maximum dimension from the tip of the self-tapping screw to the tip of the arm base is less than 18 inches (or 12-24 inches). In the fully extended position, the distance between the tip of screw and end of the arm base is at least 20 inches (possibly 24-48 inches or 28-36 inches). In addition, the distance between the tip of the screw and end of the arm base is at least 1.5 times (possibly at least 2 times or at least 3 times) greater than when in a fully retracted position. As discussed above, all or a part of the hinges can include friction adjustments for varying the stiffness of the hinge and/or locking the hinges in a desired intermediate position.

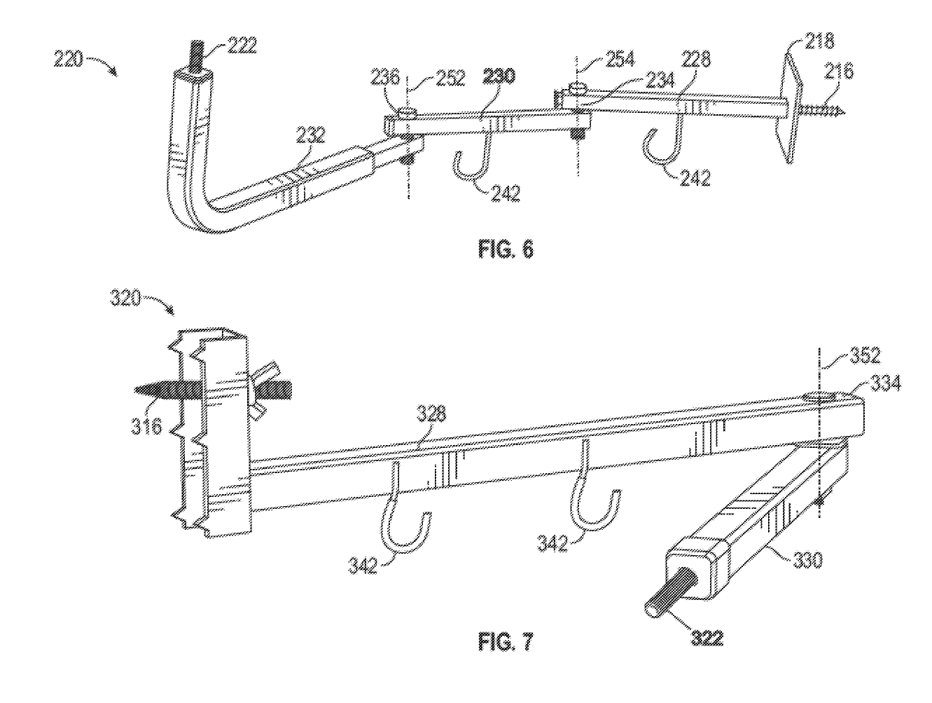

FIGS. 6-9 show examples of other possible tree mountable arm base configurations. More specifically, FIG. 6 depicts a tree mountable arm base 220 having a self-tapping screw 216, a flange 218, a first arm segment 228, a second arm segment 230, a third arm segment 232, and a male threaded projection 222. The first and second arm segments 228,230 are joined together at a first hinge 234 having a first hinge pivot axis 254. The second and third arm segments 230,232 are joined together at a second hinge 236 having a second hinge pivot axis 252. The first and second hinge pivot axes 252,254 extend substantially parallel to one another. The arm base 220 also includes accessory hooks 242 attached to the bottom of the first and second arm segments 228,230. In the embodiment depicted in FIG. 6, the male threaded projection/member 222 extends generally upwardly in a direction that is generally perpendicular to the direction of extension of the third arm segment 232 and generally parallel to the direction of extension of the hinge pivot axes 254,252. Also, in the embodiment depicted in FIG. 6, the second arm segment 230 is located generally below the first arm segment 228 at the first hinge 234, while the third arm segment 232 is located generally below the second arm segment 230 at the second hinge 236.

FIG. 7 depicts a tree mountable arm base 320 having a self-tapping screw 316, a first arm segment 328, a second arm segment 330, and a male threaded projection 322. The first and second arm segments 328,330 are joined together at a first hinge 334 having a hinge pivot axis 352. The arm base 320 also includes accessory hooks 342 attached to the bottom of the first and second arm segments 328,330.

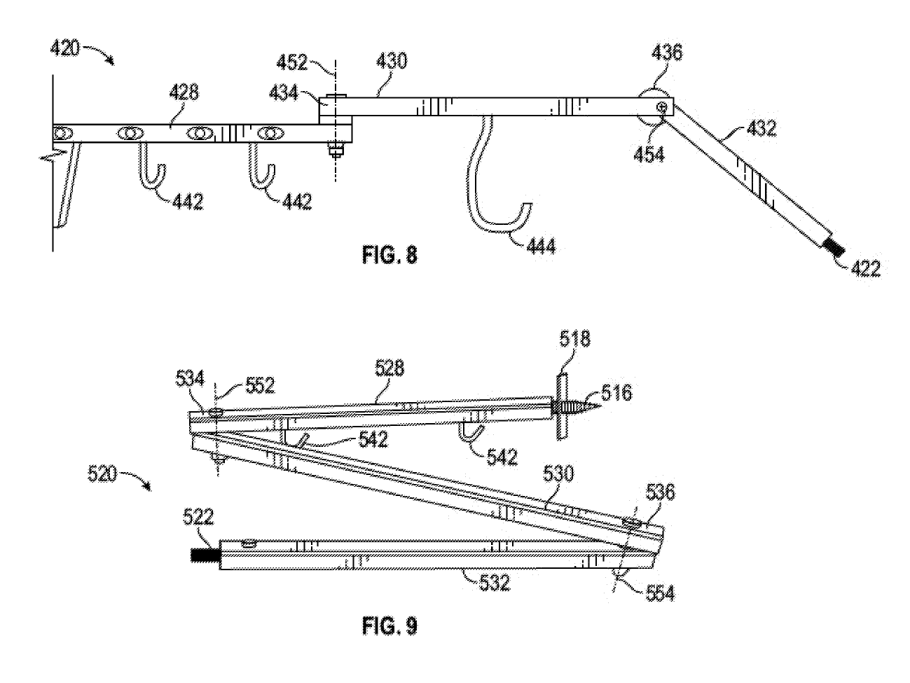

FIG. 8 depicts a tree mountable arm base 420 having a first arm segment 428, a second arm segment 430, a third arm segment 432, and a male threaded projection 422. The first and second arm segments 428,430 are joined together at a first hinge 434 having a hinge pivot axis 452. The second and third arm segments 430,432 are joined together at a second hinge 436 having a second hinge pivot axis 454. The first and second hinge pivot axes 452,454 extend substantially perpendicular with one another. The arm base 420 also includes accessory hooks 442 attached to the bottom of the first arm segment 428 and a bow hook 444 attached to the bottom of the second arm segment 430.

FIG. 9 depicts a tree mountable arm base 520 having a self-tapping screw 516, a flange 518, a first arm segment 528, a second arm segment 530, a third arm segment 532, and a male threaded projection 522. The first and second arm segments 528,530 are joined together at a first hinge 534 having a first hinge pivot axis 552. The second and third arm segments 530,532 are joined together at a second hinge 536 having a second hinge pivot axis 554. The first and second hinge pivot axes 552,554 extend substantially parallel to one another. The arm base 520 also includes accessory hooks 542 attached to the bottom of the first and second arm segments 528,530. In the embodiment depicted in FIG. 9, the male threaded projection/member 522 extends in a direction that is generally parallel to the direction of extension of the third arm segment 532 and generally parallel to the direction of extension of the hinge pivot axes 552,554.

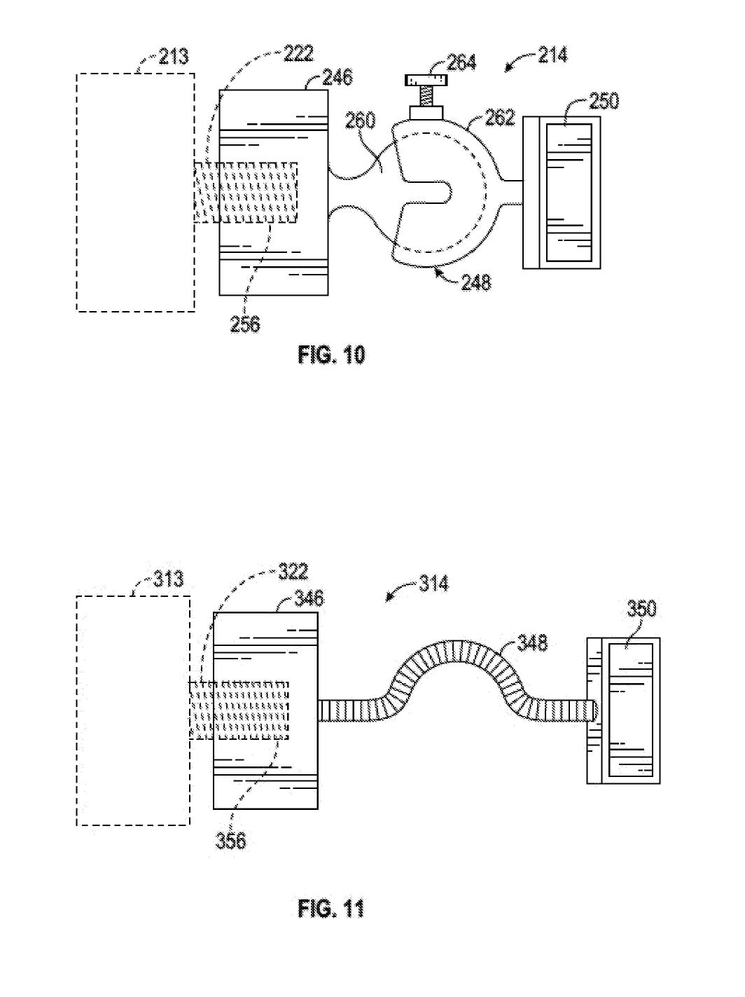

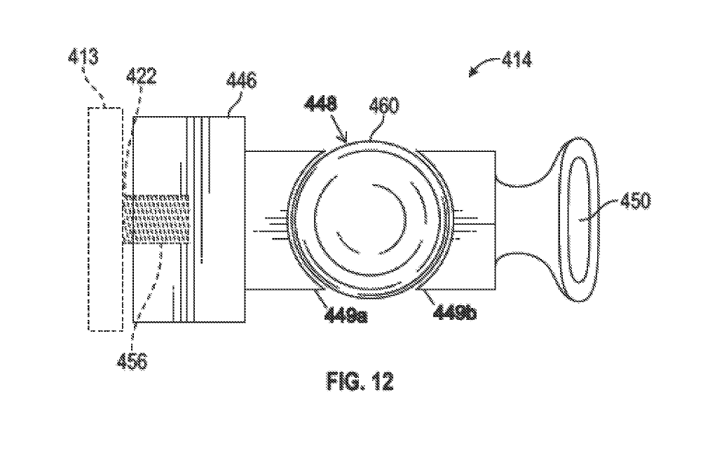

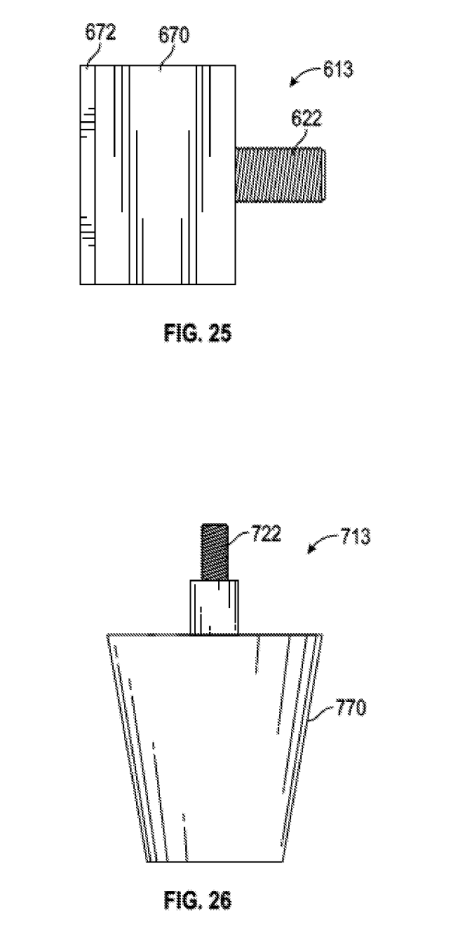

FIGS. 10-24 depict various phone mounts, each including a base connection member, a multi-axis articulating member, and a phone-holding member. The base connection member of each phone mount illustrated in FIGS. 10-24 includes a male threaded opening for receiving the female threaded member of a base (e.g., a tree mountable arm base or any base illustrated in FIGS. 25-29) to which the phone mount is connected. The male threaded opening is standard size for mounting cameras on a tripod (¼ inch diameter and 20 threads per inch), so that the phone mounts of FIGS. 1-24 can be used with a standard tripod or other camera mount device in addition to the bases described herein. Alternatively, another releasable connection mechanism can be substituted for the female threaded opening on the base connection member and the male threaded member on the arm base to allow for connection/disconnection of the phone mount to and from the tree mountable arm base and other bases. Alternative connection mechanisms for connecting the phone mount to the base include, for example, strong magnets and snap fit quick/release mechanisms. In one embodiment, the same magnet used to magnetically attach the phone to the phone holding member can be used to removably attach the phone mount to the end of the arm base. For example, in FIG. 12 (describe in detail below), the ball in the center of the phone mount can be a strong (e.g., neodymium) magnet that can simultaneously hold the phone to the phone-holding member and the phone mount to a metallic end of the arm base.

The removability of the phone mount from the tree mountable arm base allows the tree mountable arm base to remain attached to the tree and the phone mount to be removed and taken for other use (e.g., mounted on a vehicle mounting base). This removability of the phone mount from the tree mountable arm base keeps the phone mount out of the outdoor elements, which could possibly degrade the padded surface and/or reduce smooth operation of the multi-axis articulating member (e.g., ball hinge).

FIGS. 10-20 show various magnetic phone mounts that use magnet force to hold the phone to the phone-holding member. As described in further detail below, when a magnetic phone mount is used the phone and/or phone case can include or hold a ferromagnetic area that is attracted to the magnet on the magnetic phone mount. Alternatively, the phone and/or phone case can include or hold a magnet and the phone-holding member of the magnetic phone mount can simply be formed of or include a ferromagnetic material to which the magnet associated with the phone is attracted.

FIG. 10 illustrates a universal phone mount 214 that can be removably attached to a base 213. The phone mount 214 includes a base connection member 246, a multi-axis (or infinite axis) articulating member 248, and a phone-holding member 250. The base connection member 246 includes a female threaded opening 256 that can receive a male threaded member 222 of the base 213. This threaded connection between the base connection member 246 and the phone mount 214 allows the phone mount 214 to be securely connected to the base 213, while still being removable from the base 213 and connectable to any other base having a male projection with threads corresponding to the threads of the female threaded opening 256.

The multi-axis articulating member 248 depicted in FIG. 10 is a ball hinge. As discussed in further detail below, in various other embodiments, the multi-axis articulating member 248 could be any mechanism (e.g., an elongated gooseneck), that allows for movement of the phone-holding member 250 in all directions relative to the base connection member 246 while also being capable of fixing the phone-holding member 250 in a desired position relative to the base connection member 246. The ball hinge articulating member 248 of FIG. 10 includes a ball 260 rigidly connected to the base member 246, a socket 262 rigidly connected to the phone-holding member 250, and a friction adjustment member 264 coupled to the socket 262 and operable to adjust the stiffness of the ball hinge articulating member 248. When the friction adjustment member 264 is tightened, the ball hinge articulating member 248 can be locked in place. When the friction adjustment member 264 is loosened, the ball hinge articulating member 248 can be easily manipulatable into a variety of different positions. In certain embodiments, the friction adjustment member 264 is simply a threaded member (shaft or collar) that, when rotated, is forced into or away from the ball 260 to adjust the frictional force exerted against the ball 260.

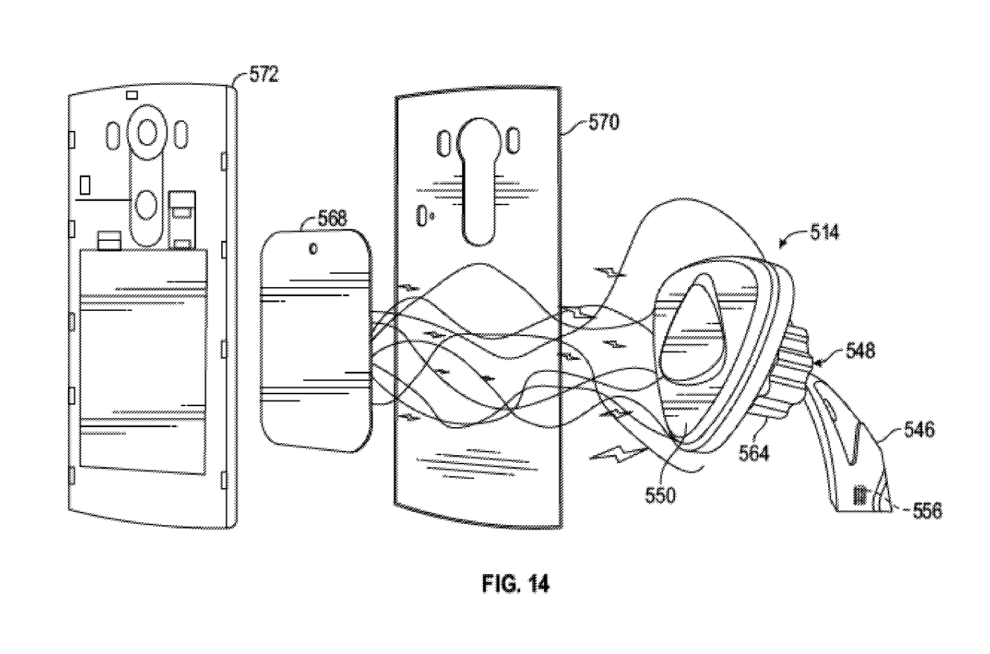

The phone-holding member 250 depicted in FIG. 10 is a magnet that holds a phone by magnetic force. The phone-holding member 250 can have a padded surface for contacting the phone in order to minimize noise when attaching/detaching the phone. The magnetic phone mount 214 may be packaged and sold with a thin metallic (ferromagnetic) plate or sticker (not shown) for positioning in, on, or adjacent to a phone to improve the strength of attachment of the phone to the phone-holding member 250. As discussed in further detail below with respect to FIG. 14, such a ferromagnetic plate or sticker can be mounted on the outside of the back of the phone, inside the back panel of the phone, between the back of the phone and the inside of the phone's protective case, or on the back of the phone's protective case. Further, the phone or case can be manufactured with an integral ferromagnetic area on the back to permit them to be readily mountable on virtually any type of magnetic phone mount. In one embodiment, the back of a phone housing and/or a phone case is manufactured with a ferromagnetic area formed of a composite material. The composite material includes a mixture of a non-ferromagnetic material and a ferromagnetic material. The weight ratio of the non-ferromagnetic material to the ferromagnetic material in the composite material can be in the range of 0.1:1 to 10:1, 0.25:1 to 5:1, or 0.75:1 to 2.5:1. The non-ferromagnetic material of the composite material can be the same material (e.g., synthetic resin) used to make the non-ferromagnetic areas of the housing/case adjacent the ferromagnetic area. The ferromagnetic (e.g., iron-containing) material of the composite material can be ferromagnetic flakes, particles, wires, threads, sheets, and/or mesh embedded in the non-ferromagnetic material.

FIG. 11 illustrates a universal phone mount 314 that can be removably attached to a base 313. The phone mount 314 includes a base connection member 346, a multi-axis articulating member 348, and a phone-holding member 350. The base connection member 346 includes a female threaded opening 356 that can receive a male threaded member 322 of the base 313. This threaded connection between the base connection member 346 and the phone mount 314 allows the phone mount 314 to be securely connected to the base 313, while still being removable from the base 313 and connectable to any other base having a male projection with threads corresponding to the threads of the female threaded opening 356. The multi-axis articulating member 348 depicted in FIG. 11 is an elongated gooseneck that can be manipulated into multiple positions. The gooseneck articulating member 348 is configured to automatically retain itself in whatever shape/position it is manually manipulated into. The phone-holding member 350 depicted in FIG. 11 can be the same as the phone-holding member 250 described with respect to FIG. 10.

FIG. 12 illustrates a universal phone mount 414 that can be removably attached to a base 413. The phone mount 414 includes a base connection member 446, a multi-axis articulating member 448, and a phone-holding member 450. The base connection member 446 includes a female threaded opening 456 that can receive a male threaded member 422 of the base 413. The multi-axis phone articulating member 448 depicted in FIG. 12 can include a spherical ball 460 and two sockets 449a,b. In one embodiment, the spherical ball 460 can be a magnet (e.g., a neodymium magnet) that is received between and attracted to the sockets 449a,b, which are made of a ferromagnetic material. Alternatively, the sockets 449a,b can be magnetic and the ball 460 can be ferromagnetic. In either embodiment, the phone-holding member 450 is held to the ball 450 by magnetic force and is manipulatable relative to the ball 460 on multiple axes. The friction caused by the magnetic force between the socket 449b and the ball 460 causes the phone-holding member 450 to be retained in whatever position it is manually manipulated into. In certain embodiments, the ball 460 is a made of a ferromagnetic material coated with a layer of a non-ferromagnetic material (e.g., a synthetic resin). The non-ferromagnetic material can protect the ferromagnetic ball from corrosion and/or can help the sockets slide smoothly and quietly on the coated surface. The phone-holding member 450 depicted in FIG. 12 can be substantially the same as the phone-holding member 250 described with respect to FIG. 10.

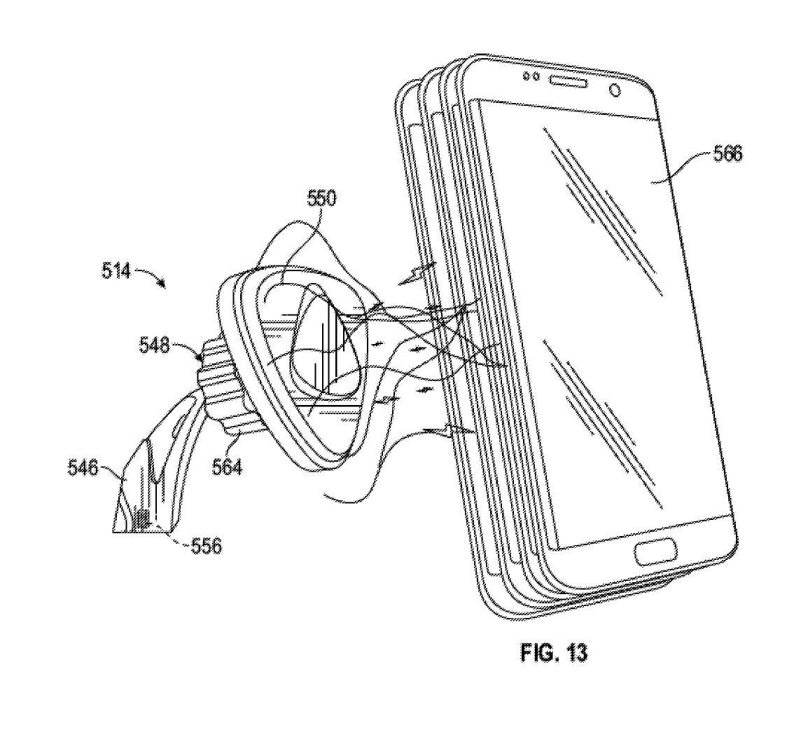

FIGS. 13 and 14 illustrate a universal phone mount 514 that can be removably attached to a base (not shown) via a female threaded opening 556. The phone mount 514 includes a base connection member 546, a multi-axis articulating member 548, and a phone-holding member 550 that holds a phone 566 by magnetic force. The multi-axis phone articulating member 548 can be a ball hinge that includes a friction adjustment collar 564. Rotation of the friction adjustment collar 564 adjusts the stiffness of the ball hinge articulating member 548. FIG. 14 illustrates an embodiment where a ferromagnetic plate/sticker 568 (which can be packaged and sold along with the phone mount 514) is inserted between the phone's back cover 570 and main body 572. Alternatively, the ferromagnetic plate/sticker 568 can be inserted between the back of the phone and a phone case, or the ferromagnetic plate/sticker 568 can simply be adhered to the exposed back of the phone. As discussed above, it may be preferable for the back of the phone or phone case to be manufactured with a ferromagnetic area integrally formed therein, as this type of phone/case would avoid the need for a separate ferromagnetic plate/sticker. The phone-holding member 550 depicted in FIGS. 13 and 14 can be substantially the same as the phone-holding member 250 described with respect to FIG. 10.

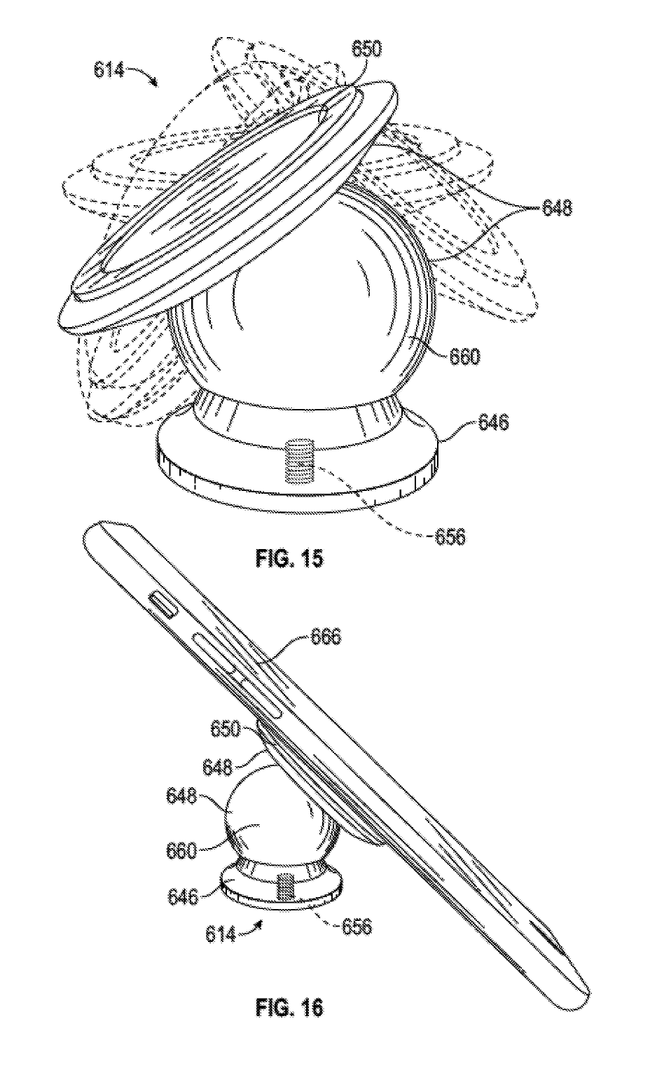

FIGS. 15 and 16 illustrate a universal phone mount 614 that can be removably attached to a base (not shown) via a female threaded opening 656. The phone mount 614 includes a base connection member 646, a multi-axis articulating member 648, and a phone-holding member 650 that holds a phone 666 by magnetic force. The multi-axis phone articulating member 648 includes a ferromagnetic ball 660. The phone-holding member 650 includes a magnet (e.g., a neodymium magnet) that performs the dual function of holding a back socket of the phone-holding member 650 against the ball 650 and holding the phone 665 against the front surface of phone-holding member 650. The friction caused by the magnetic force between the ball 660 and the back of the phone-holding member 650 causes the phone-holding member to be retained in whatever position it is manually manipulated into. The friction caused by the magnetic force between the phone-holding member 650 and the back of the phone (or phone case) 666 holds the phone 660 to the phone-holding member 650 and prevents the phone 660 from easily sliding off the phone-holding member 650. In certain embodiments, the ball 660 is a made of a ferromagnetic material (e.g., steel) that is coated with a layer of a non-ferromagnetic material (e.g., a synthetic resin). The non-ferromagnetic material used for the coating can (1) protect the ferromagnetic spherical core from corrosion, (2) help the phone-holding member 650 slide smoothly and quietly on the coated surface, and (3) ensure that the proper amount of friction between the phone-holding member 650 and the surface of the ball 660 is maintained. In certain embodiments, the coated ball 660 has a greater coefficient of static friction than the uncoated ball 660. For example, the coefficient of static friction of the coat ball 660 can be at least 1.1, 1.25, 1.5, or 2 times greater than the coefficient of static friction of the uncoated ball 660. Further, it can be preferred for the difference between the coefficient of static friction and the coefficient of dynamic friction of the surface of the ball to be relatively large, so that the phone-holding member 650 and phone 660 are relatively easy to manipulate, but remain steady when fixed in their desired orientation. Accordingly, the coefficient of static friction of the surface of the ball 660 can be at least 1.1, 1.2, 1.3, 1.5, or 1.5 times greater than the coefficient of dynamic friction of the surface of the ball 660. The phone-holding member 650 depicted in FIGS. 15 and 16 can be substantially the same as the phone-holding member 250 described with respect to FIG. 10.

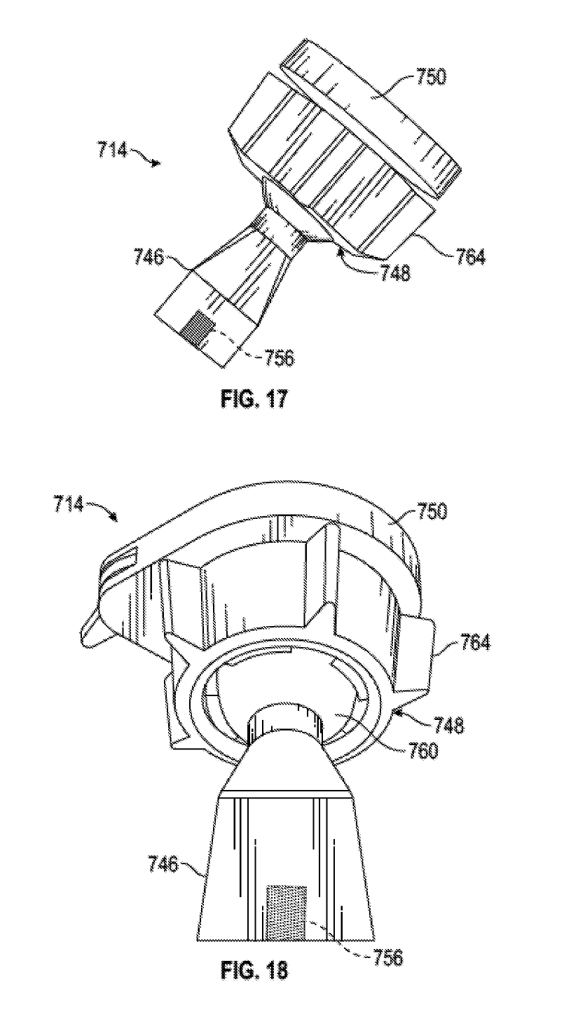

FIGS. 17 and 18 illustrate a universal phone mount 714 that can be removably attached to a base (not shown) via a female threaded opening 756. The phone mount 714 includes a base connection member 746, a multi-axis articulating member 748, and a phone-holding member 750 that holds a phone (not shown) by magnetic force. The multi-axis phone articulating member 748 can be a ball hinge that includes a friction adjustment collar 764. Rotation of the friction adjustment collar 764 adjusts the stiffness of the ball hinge articulating member 748. The phone-holding member 750 depicted in FIGS. 17 and 18 can be substantially the same as the phone-holding member 250 described with respect to FIG. 10.

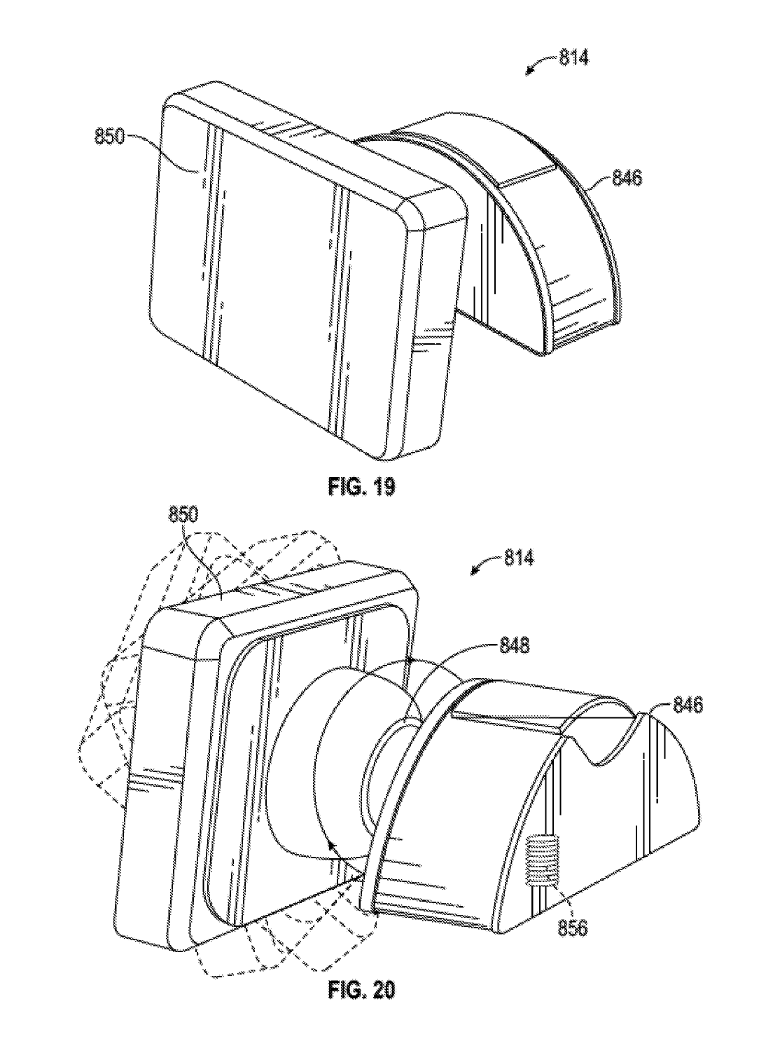

FIGS. 19 and 20 illustrate a universal phone mount 814 that can be removably attached to a base (not shown) via a female threaded opening 856. The phone mount 814 includes a base connection member 846, a multi-axis articulating member 848, and a phone-holding member 850 that holds a phone (not shown) by magnetic force. The multi-axis phone articulating member 848 can be a ball hinge. The phone-holding member 850 depicted in FIGS. 19 and 20 can be substantially the same as the phone-holding member 250 described with respect to FIG. 10.

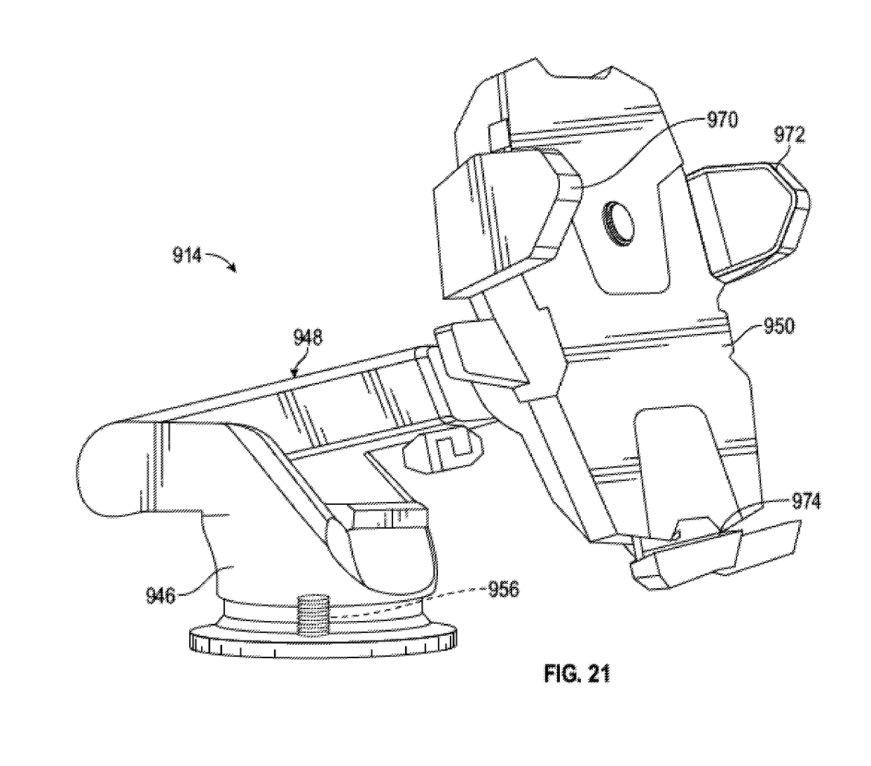

FIGS. 21-24 illustrate physical (non-magnetic) phone mounts that are configured to hold a phone between at least two opposing physical members that exert opposing forces on the phone. One or both of the opposing physical members can be spring-loaded, so that a phone can be loaded into the phone mount by (a) manually overcoming the spring force to increase the distance between the opposing physical members, (b) inserting a phone between the physical members, and (c) allowing the spring force to urge the physical members towards one another and into contact with opposite sides of the phone. The force exerted by the physical members on the phone is sufficient to hold the phone between the physical members.

FIGS. 21 and 22 depict a physical phone mount 914 that can be removably attached to a base (not shown) via a female threaded opening 956. The phone mount 914 includes a base connection member 946, a multi-axis articulating member 948, a phone-holding member 950 that holds a phone 966 by physical force. The multi-axis phone articulating member 848 can include a hinged, telescoping arm and a ball hinge. The ball hinge can include a friction adjustment collar 964. Alternatively, the ball hinge could include a friction adjustment screw similar to the friction adjustment member 264 depicted in FIG. 10 (e.g., having a threaded shaft and a manually turnable knob). The phone-holding member 950 depicted in FIGS. 21 and 22 includes two opposing physical contact members 970 and 972. The phone-holding member 960 includes a spring (not shown) that biases at least one of the physical contact members 970,972 toward the other of the physical contact members 970,972. The phone-holding member 950 also include a fixed bottom physical contact member 974 that also contacts a lower edge of the phone 974. The phone 966 is loaded into the phone-holding member 950 by manually forcing one or both of the physical contact members 970,972 apart by overcoming the inward bias of the spring. Once the physical contact members 970,972 are spread apart the phone 966 can be inserted into the space between the physical contact members 970,972 and above the bottom physical contact member 974. When the physical contact members 970,972 are released, they contact opposite edges of the phone 966 and squeeze the phone 966 between them, thereby holding the phone in place. To remove the phone 966, one or both of the physical contact members can be manually moved against the spring force to release the gripping force on the phone 966.

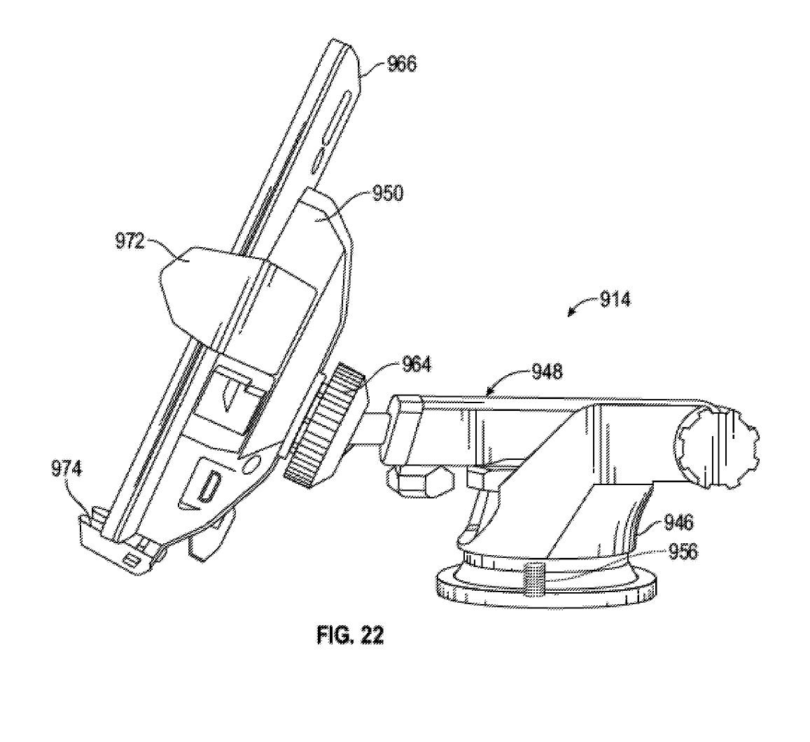

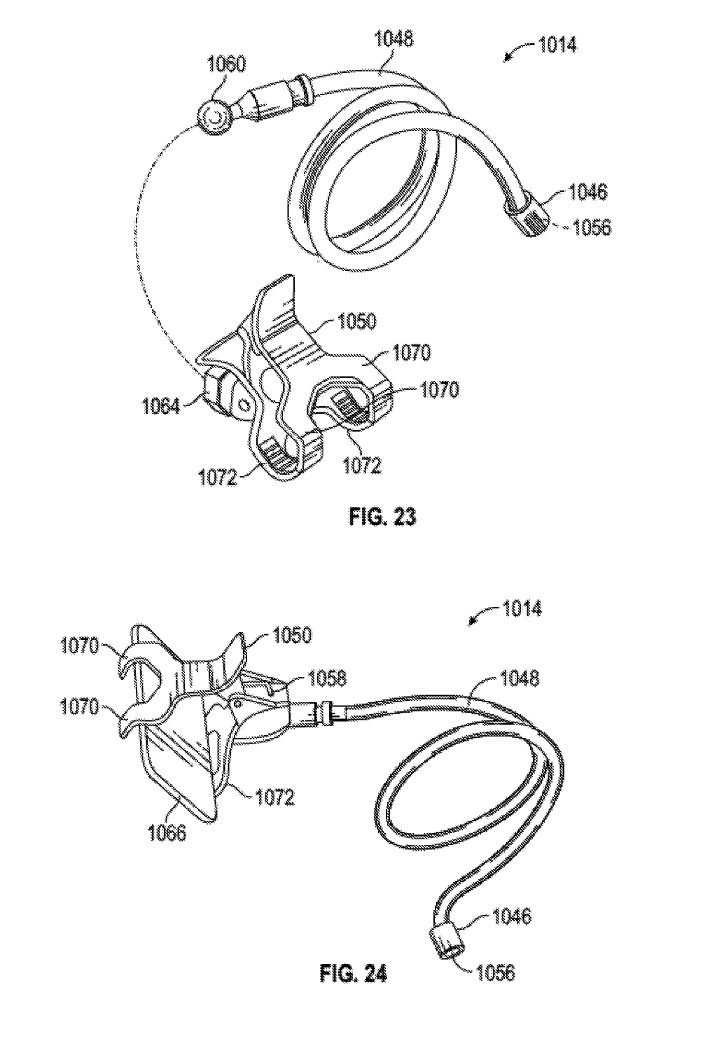

FIGS. 23 and 24 depict a physical phone mount 1014 that can be removably attached to a base (not shown) via a female threaded opening 1056. The phone mount 1014 includes a base connection member 1046, a multi-axis articulating member 1048, and a phone-holding member 1050 that holds a phone 1066 by a physical holding/gripping force. The multi-axis phone articulating member 1048 can include a self-holding flexible elongated goose-neck member and a ball hinge. The ball hinge can include a friction adjustment collar 1064. Alternatively, the ball hinge could include a friction adjustment screw similar to the friction adjustment member 264 depicted in FIG. 10 (i.e., having a threaded shaft and a manually turnable knob). The phone-holding member 1050 depicted in FIGS. 23 and 24 includes two opposing physical contact members 1070 and 1072. The phone-holding member 1050 includes a spring 1058 that biases at least one of the physical contact members 1070,1072 toward the other one. The phone 1066 is loaded into the phone-holding member 1050 by manually forcing the physical contact members 1070,1072 apart and overcoming the bias of the spring 1058. Once the physical contact members 1070,1072 are spread apart and manually held in the opened position, the phone 1066 can be inserted into the space between the physical contact members 1070,1072. Thereafter, when the physical contact members 1070,1072 are released, they contact opposite edges of the phone 1066 and squeeze the phone 1066 between them, thereby holding the phone 1066 in place. To remove the phone 1066, one or both of the physical contact members 1070,1072 can be manually moved against the spring force to release the gripping force on the phone 1066.

FIGS. 25-29 illustrate other bases suitable for use/sale with the universal phone mounts described above. A tree mountable arm base with a multi-segment articulating arm was described above with respect to FIGS. 1-9. The tree mountable arm base described above and the other bases illustrated in FIGS. 25-29 can be interchangeably used with any of the phone mounts described above with respect to FIGS. 10-24.

FIG. 25 illustrates an adhesive base 613 that includes a structural base member 670, a male threaded projection 622 extending from one side of the structural base member 670, and an adhesive 672 position on another side of the structural base member 670. The adhesive 672 can be, for example, a peal-and-stick adhesive component that allows the base 613 to be permanently mounted on virtually any clean and relatively flat surface (e.g., a desk, a vehicle dash, or a vehicle windshield). In certain embodiments, the adhesive 672 could be replaced by a magnet (or attached to a magnet) to make the base a magnetic base suitable for attachment to any ferromagnetic surface.

FIG. 26 illustrates a cupholder base 713 that includes a structural base member 770 and a male threaded projection 722 extending from the top of the structural base member 770. The structural base member 770 is shaped to fit in a standard vehicle cupholder. The structural base member 770 can be weighted (e.g., greater than 8 ounces) to increase the stability of the cupholder base 713.

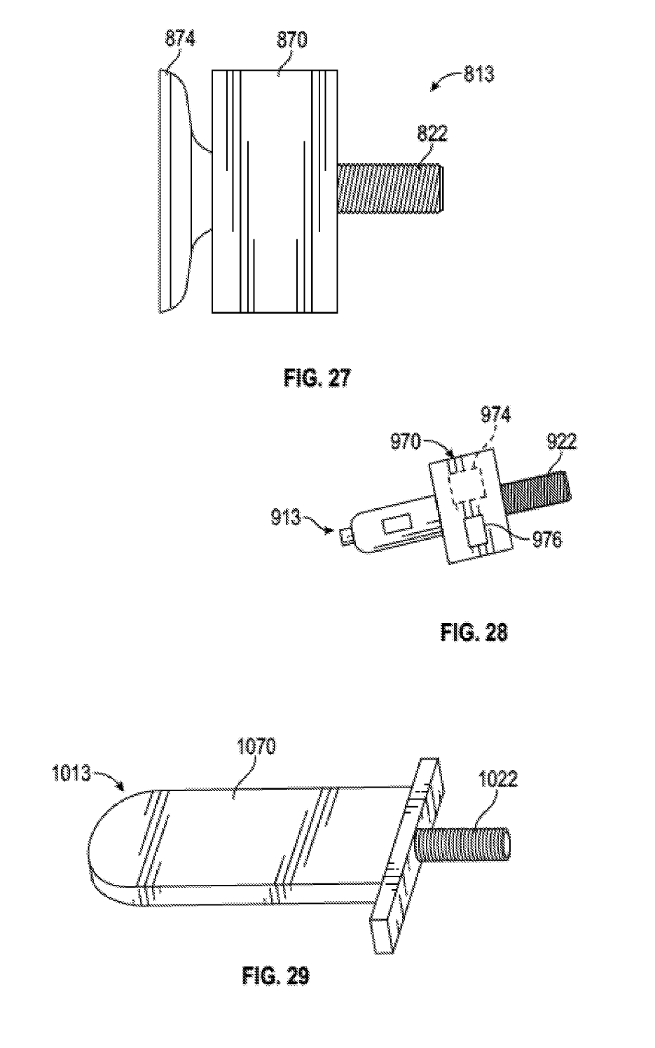

FIG. 27 illustrates a suction cup base 813 that includes a structural base member 870, a male threaded projection 822 extending from one side of the structural base member 870, and a suction cup 872 positioned on another side of the structural base member 870. The suction cup 872 can be removably mounted on virtually any smooth, clean, relatively flat surface (e.g., a desk, a vehicle dash, or a vehicle windshield).

FIG. 28 illustrates a vehicle charging base 913 that includes a structural base member 970, a male threaded projection 922, a transformer 974, and a USB port 976. The structural base member 970 includes a projection configured to fit into a standard 12V female slot/receptacle for support by the electrical slot. In addition, the vehicle charging base electrically connects with the 12V slot so the vehicle charging base 913 can be used to charge a phone that is simultaneously supported by the base 913. The transformer of the base 913 can function to step down voltage from 12 volts DC to standard USB voltage (about 5 volts). The USB port 976 can be used for plugging in a USB charge/power cord.

FIG. 29 illustrates a CD-slot base 1013 that includes a structural base member 1013 and a male threaded projection 1022. The CD-slot base 1013 is configured to be received and held in a standard vehicle CD/DVD player. The male threaded projection 1022 extends out from the base member 1013 and away from the CD/DVD player.

In addition to the above-described bases, any standard camera mount (e.g., tripod, Go Pro mounts, etc.) can be used as the base because the threaded projections of the bases are of a standard size (i.e., ¼ inch diameter and 20 threads per inch). The phone mount system described herein can include multiple interchangeable bases and multiple interchangeable phone mounts. This interchangeability of bases and phone mounts is accomplished using a common attachment mechanism, such as the common male threaded projections on the bases and the common female threaded openings on the phone mounts. The interchangeability of bases and phone mounts allows for an entire product line of interchangeable bases and phone mounts to be offered. Customers can select which base(s) and phone mount(s) work best for their needs. In addition, the present invention contemplates systems/kits that include multiple base and/or phone mount options packaged for sale together. For example, a single hunting package/kit could include a tree mountable arm base for hunting, an adhesive base for a desk, a 12-volt charging base for a vehicle, a magnetic phone mount that can be used on any of the bases, and/or a ferromagnetic plate for attachment to the phone. Of course, each base and phone mount can be sold individually, so that customers can mix and match for their needs, thereby avoiding purchasing unnecessary components.

1. A tree mountable device holder for holding a phone, said tree mountable device holder comprising:
an articulating arm including first, second, and third rigid arm segments and first and second single-axis hinges, wherein said first single-axis hinge couples said first and second rigid arm segments to one another, wherein said second single-axis hinge couples said second and third rigid arm segments to one another, wherein said second rigid arm segment is coupled between said first and second rigid arm segments by said first and second hinges respectively, wherein the pivot axes of said first and second hinges are substantially parallel to one another;
a self-tapping screw coupled to said first rigid arm segment at an end of said rigid arm segment spaced from said first hinge;
a male threaded projection coupled to said third rigid arm segment at a location spaced from said second hinge; and
a physical phone mount coupled to said third rigid arm segment via said male threaded projection, wherein said phone mount includes a female threaded opening for receiving said male threaded projection,
wherein said phone mount includes a ball hinge and a phone-holding member configured to securely hold a phone,
wherein said phone-holding member comprises at least two opposing physical members configured to contact and exert a holding force on said phone.

2. The tree mountable device holder of claim 1, wherein said ball hinge comprises a friction adjustment member for varying the stiffness of said ball hinge and permitting said ball hinge to lock said phone-holding member in a desired position.

3. The tree mountable device holder of claim 1, wherein said physical phone mount comprises a spring for urging at least one of said opposing members towards the other of said opposing members, thereby causing said opposing members to exert opposing forces on said phone.

4. The tree mountable device holder of claim 1, wherein said male threaded projection has a ¼ inch diameter and 20 threads per inch.

5. The tree mountable device holder of claim 1, wherein said male threaded projection extends substantially perpendicular to the direction of extension of said third rigid arm segment.

6. The tree mountable device holder of claim 1, wherein each of said first, second, and third rigid arm segments is formed of a tubular member having four substantially flat sides.

7. The tree mountable device holder of claim 6, wherein each of said first, second, and third rigid arm segments has a substantially rectangular cross-section.

8. The tree mountable device holder of claim 1, wherein said second rigid arm segment is positioned generally below said first rigid arm segment at said first hinge, wherein said third rigid arm segment is positioned generally below said second rigid arm segment at said second hinge.

9. The tree mountable device holder of claim 1, wherein at least one of said rigid arm segments includes a hook for hanging an archery bow and/or hunting accessories from said articulating arm.

10. A tree mountable device holder comprising:
an articulating arm including at least two rigid arm segments and a single-axis hinge coupling said rigid arm segments to one another;
a screw member coupled to a first end of said articulating arm; and
a phone mount coupled to a second end of said articulating arm,
wherein said phone mount includes a multi-axis articulating member and a phone-holding member configured to securely hold a phone,
wherein said multi-axis articulating member is coupled between said articulating arm and said phone-holding member and is configured to permit multi-axis articulation of said phone-holding member relative to said articulating arm.

11. The tree mountable device holder of claim 10, wherein said phone-holding member is a magnetic mount comprising a magnet for holding said phone via magnetic force.

12. The tree mountable device holder of claim 11, wherein said phone-holding member comprises a pad presenting a phone-contacting surface, wherein said pad is configured to reduce noise during attachment and detachment of said phone to and from said phone-holding member.

13. The tree mountable device holder of claim 10, wherein said phone-holding member is a physical mount comprising at least two opposing members that exert opposing forces on said phone.

14. The tree mountable device holder of claim 13, wherein said physical phone mount comprises a spring for urging at least one of said opposing members towards the other of said opposing members, thereby causing said opposing members to exert opposing forces on said phone.

15. The tree mountable device holder of claim 10, wherein said screw is a self-tapping screw capable of being manually screwed into a tree without need for a pre-drilled hole.

16. The tree mountable device holder of claim 10, further comprising a flange coupled to said screw and operable to engage a tree when said screw is tightened into a tree.

17. The tree mountable device holder of claim 10, wherein said device holder has a holding capacity, as defined herein, of at least 10 pounds.

18. The tree mountable device holder of claim 10, wherein at least one of said rigid arm segments includes a hook for hanging an archery bow and/or hunting accessories from said articulating arm.

19. The tree mountable device holder of claim 10, wherein said multi-axis articulating member comprises a ball hinge.

20. The tree mountable device holder of claim 19, wherein said ball hinge comprises a friction adjustment member for varying the stiffness of said ball hinge and permitting said ball hinge to lock said phone-holding member in a desired position.

21. The tree mountable device holder of claim 10, wherein said multi-axis articulating member comprises a self-holding elongated gooseneck member, wherein said gooseneck member is configured to be manually manipulated into a desired position and retained by itself in that position until manually manipulated to another position.

22. The tree mountable device holder of claim 10, wherein said arm comprises first, second, and third rigid arm segments and first and second single-axis hinges, wherein said first rigid arm segment is coupled to said screw, wherein said third rigid arm segment is coupled to said phone mount, wherein said second rigid arm segment is coupled between said first and second rigid arm segments by said first and second hinges respectively, wherein the pivot axes of said first and second hinges are substantially parallel to one another.

23. The tree mountable device holder of claim 10, wherein said second end of said articulating arm comprises a male threaded member, wherein said phone mount comprises a female threaded opening within which said male threaded member is removably received.

24. The tree mountable device holder of claim 23, wherein said male threaded member has a ¼ inch diameter and 20 threads per inch.

25. The tree mountable device holder of claim 10, wherein said articulating arm is shiftable between a fully retracted configuration and a fully extended configuration, wherein the maximum dimension of said articulating arm in said fully extended configuration is at least twice the maximum dimension of said articulating arm in said fully retracted configuration.

26. The tree mountable device holder of claim 25, wherein said articulating arm is further shiftable into a variety of different intermediate positions, wherein said articulating arm is lockable in each of said fully retracted, fully extended, and intermediate positions.

27. A method of using a device holder, said method comprising the steps of:
(a) securing an arm base having a screw and an articulating arm to a tree via said screw;
(b) manipulating said articulating arm into a desired position;
(c) securing a phone to a phone mount coupled to said articulating arm; and
(d) recording and/or playing video with said phone while said phone is held only by said phone mount.

28. The method of claim 27, wherein step (a) includes inserting said screw into a substantially vertical surface of said tree and securing said arm base to said tree in an elevated location on said tree near a tree stand seat.

29. The method of claim 27, wherein step (d) includes recording wild game being hunted.

30. The method of claim 27, further comprising hanging an archery bow and/or hunting accessories from one or more hooks mounted on said articulating arm.

31. The method of claim 27, wherein step (b) includes manipulating said articulating arm in only a single, substantially horizontal plane, further comprising manipulating said phone mount on more than one axis so that said phone is positioned into a desired orientation.

32. The method of claim 31, further comprising tightening an adjustment mechanism of said phone mount to thereby lock said phone in said desired orientation, wherein said recording and/or playing of step (d) is carried out while said phone is in said desired orientation.

33. The method of claim 27, further comprising removing said phone mount from said arm base, while said arm base remains connected to said wooden member and, while said arm base is connected to said wooden member, securing said phone mount to another type of base having a substantially different configuration than said arm base and using said phone mount on said another type of base to hold said phone or a different phone.

34. The method of claim 33, wherein said phone mount includes a female threaded opening, wherein said arm base comprises a first male threaded projection, and said another type of base comprises a second male threaded projection, wherein said female threaded opening is configured to interchangeably receive said first and second male threaded projections.

35. The method of claim 33, where said another type of base is selected from the group consisting of an adhesive base, a suction base, a cup holder base, a 12 volt charging base, and a CD-slot base.

36. The method of claim 27, wherein said securing of step (a) includes—
(i) partially screwing said screw into a tree,
(ii) subsequent to step (i), adjusting the axial position of a flange adjacent to said screw, and
(iii) subsequent to step (ii), further screwing said screw into said wooden member until said flange firmly engages said tree and said arm base is in a proper orientation.
